(19) United States
(12) Patent Application Publication
(10) Pub. No.: US 2012/0321833 A1
(43) Pub. Date: Dec. 20, 2012

(54) PROGRAMMABLE PELLET PRESS

(76) Inventors: Alan Ekquist, Clinton, MI (US); Michael R. Harvey, Milford, MI (US); Donald Dotson, Toledo, OH (US)

(21) Appl. No.: 13/564,896

(22) Filed: Aug. 2, 2012

Related U.S. Application Data
(60) Provisional application No. 61/550,585, filed on Oct. 24, 2011.

(51) Int. Cl. B28B 17/00

(52) U.S. Cl. 428/64.1; 425/157

(57) ABSTRACT

A programmable pellet press for compressing a powdered sample and forming a sample disc, including a hydraulic mechanism for compressing the sample in a mold operatively and electrically connected to a control mechanism for commanding an exertion of low constant preloading pressure followed by pressure increases with constant pressure dwell times upon the hydraulic mechanism. An algorithm for a programmable pellet press on computer readable media including performing a pressurization subroutine, performing a proportional-integral-derivative (PID) feedback loop, performing a depressurization subroutine, and performing an unloading subroutine when pressure is at a baseline level. A method of compressing a powdered sample into a sample disc by loading the powdered sample into a mold of a programmable pellet press, from a baseline pressure, increasing hydraulic pressure and maintaining a preloading pressure against the sample, performing pressure increases upon the sample, depressurizing the sample, and forming a sample disc. A sample disc formed.

### CROSS-REFERENCE TO RELATED APPLICATIONS

This application claims the benefit of priority to U.S. Provisional Patent Application Ser. No. 61/550,585, filed Oct. 24, 2011, which is incorporated herein by reference.

### BACKGROUND OF THE INVENTION

1. Technical Field

The invention relates to presses for compressing powdered samples into pellets, and more specifically to presses programmable to exert predetermined patterns of pressure upon powdered samples.

2. Background Art

The composition of samples of metal, semiconductors, minerals, pharmaceuticals, and other materials can be analyzed by X-ray fluorescence (XRF), optical emission spectroscopy (OES), and similar bombardment and emission analyses. Samples are usually prepared for analysis by loading powdered sample material into a mold and compressing it in a pellet press, usually to form a flattened sample disc of homogenous composition and uniform thickness. Sample discs are often formed by hydraulically powered pellet presses. In this type of press, powdered sample is loaded into a cylindrical mold, and a hydraulically powered piston is drives the sample into the mold to form the sample disc.

A common problem encountered in the use of pellet presses is the production of sample discs of insufficient integrity, that is, discs with a tendency to break, chip, or disintegrate during molding, unloading from the mold, or analysis. This problem results in loss of sample and, more seriously, ruinously expensive damage to the internal components of analysis instruments.

It is recognized that sample disc integrity can be improved through the use of appropriate compression protocols. Pellet presses of the prior art include programmed compression protocols that allow pressure to be applied either sharply or at a continuous rate of increase and held for a defined time, in a reproducible manner that eliminates user-introduced variations in pressure application and judgment. While these protocols can improve the integrity of sample discs, they still leave important problems unsolved.

As a powdered sample is compressed, it can accumulate air-filled voids that weaken the integrity of the resulting sample disc, especially if the sample disc is exposed to the vacuum characteristic of the sample chambers of many analysis instruments. There is a need for devices and methods that minimize or eliminate such voids during the compression process.

As a powdered sample is compressed, its resistance to further compression can change. These changes can occur too quickly to allow a human operator adjust compressive force to maintain uniform pressure. Existing pellet presses include no provisions for such adjustments. The resulting variations in pressure application are detrimental to the uniformity and structural integrity of resulting sample discs. There is a need for a feedback control system that efficiently maintains uniform pressure on a powdered sample despite instantaneous changes in sample resistance.

Pellet presses are usually designed to accommodate molds of many different diameters. This creates another variable that can affect sample integrity. The pressure applied to a mold varies with the area to which the pressure is applied. Thus, a hydraulic press that applies hydraulic force x to a mold of diameter d will exert greater pressure per unit area of the mold than the same press applying the same force x to mold of diameter 2d. Currently, the adaptation of pellet pressing protocols to molds of different dimensions involves rough estimation of force adjustments from standard charts. There is a need for a pellet press that can automatically and reproducibly scale pressures according to mold size so that a single pellet pressing protocol can be used to automatically and reproducibly to apply the same pressure to molds of different sizes.

### SUMMARY OF THE INVENTION

The present invention provides for a programmable pellet press for compressing a powdered sample and forming a sample disc, including a hydraulic mechanism for compressing the sample in a mold operatively and electrically connected to a control mechanism for commanding an exertion of low constant preloading pressure followed by pressure increases with constant pressure dwell times upon the hydraulic mechanism.

The present invention provides for an algorithm for a programmable pellet press on computer readable media including performing a pressurization subroutine, performing a proportional-integral-derivative (PID) feedback loop, performing a depressurization subroutine, and performing an unloading subroutine when pressure is at a baseline level.

The present invention also provides for a method of compressing a powdered sample into a sample disc by loading the powdered sample into a mold of a programmable pellet press, from a baseline pressure, increasing hydraulic pressure and maintaining a preloading pressure against the sample, performing pressure increases upon the sample, depressurizing the sample, and forming a sample disc.

The present invention further provides for a sample disc formed by the above method.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 shows a schematic diagram of the hydraulic circuit of a pellet press of the present invention;

FIG. 2 shows a block diagram of the control system of the present invention;

FIG. 3 shows a graphic representation, in terms of pressure change over time, of a method for compressing a powdered sample (in this example, high silica powder) that entails stepped increases in pressure followed by continuous depressurization; and

FIG. 4 shows a flow chart of the methodology implemented by the real time control algorithms of the present invention.

### DETAILED DESCRIPTION OF THE INVENTION

The present invention is generally directed to a programmable pellet press, indicated at 100 in the FIGURES, for compressing a powdered sample into a mold (not shown) in order to form a sample disc.

As used herein, “sample disc” denotes a compressed pellet of powdered material, and includes compressed objects of any shape, including pellets, and briquettes.

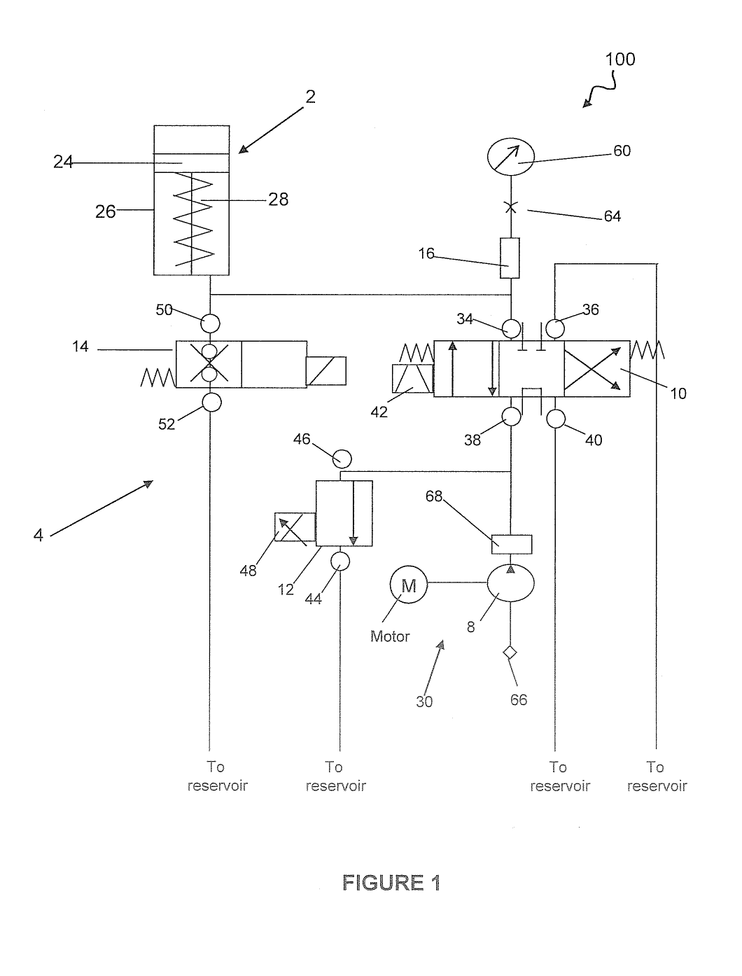

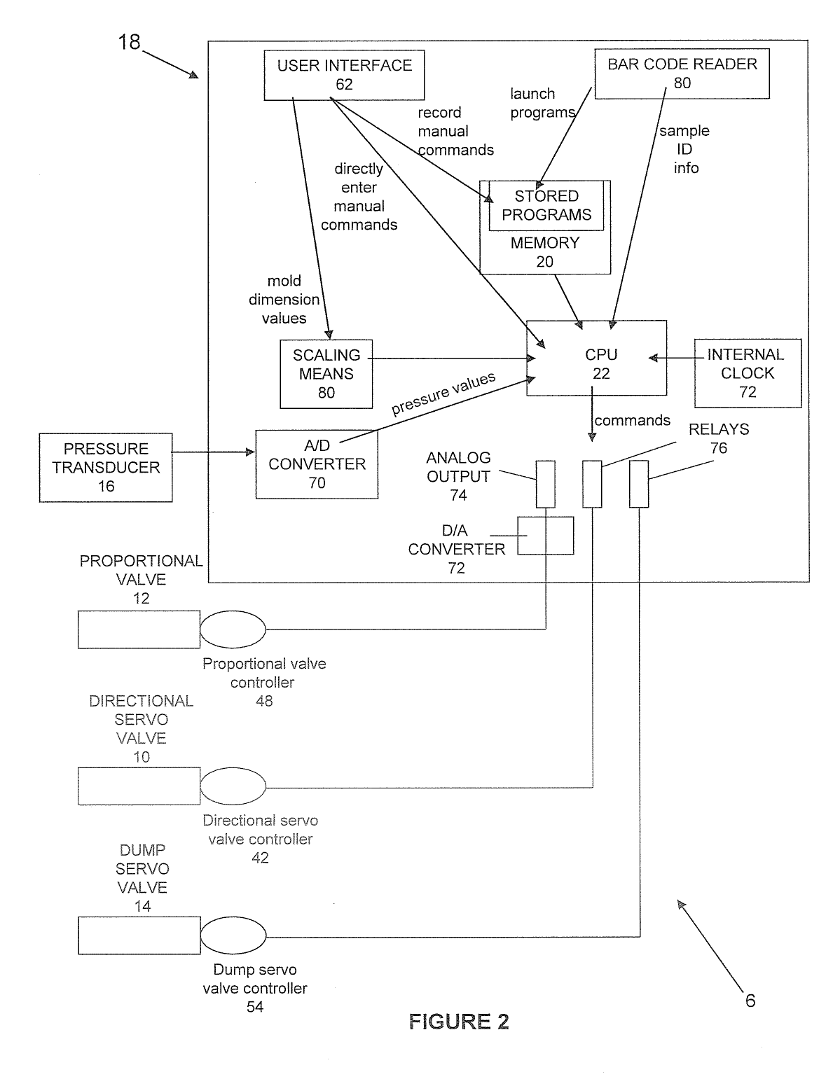

The programmable pellet press 100 includes a hydraulic actuator 2 to compress the powdered sample into the mold, a hydraulic circuit 4 (generally shown in FIG. 1) operatively connected to the hydraulic actuator 2, to apply hydraulic pressure to the hydraulic actuator 2, and a control system 6 (generally shown in FIG. 2) operatively and electronically connected to the hydraulic circuit 4 for automated regulation of the application and removal of pressure upon the hydraulic actuator 2. The hydraulic actuator 2 preferably includes a piston 24 slidably disposed within a hydraulic cylinder 26, additionally including a spring return 28 to facilitate retraction of the piston 24.

The hydraulic actuator 2 can include any device capable of holding a sample mold in place and subjecting powdered sample in the mold to pressure exerted by an assembly including a piston 24 slidingly engaged in a hydraulic cylinder 26. An exemplary actuator is the bridge assembly (not shown) of the Model PSP80K pellet press (Mikron Digital Instruments, Inc., Livonia Mich.), which accommodates sample molds of 31 mm, 35 mm, and 40 mm.

The hydraulic circuit 4 includes a hydraulic pump 8 for drawing hydraulic fluid from a reservoir (not shown) and supplying the hydraulic fluid under pressure to the hydraulic actuator 2; a directional servo valve 10 interposed between the hydraulic pump 8 and the hydraulic actuator 2 for directing hydraulic fluid either toward the hydraulic actuator 2 or toward the reservoir, to permit the pressurization and depressurization of the hydraulic actuator 2; a proportional valve 12 interposed between the hydraulic pump 8 and the directional servo valve 10 for proportionally dividing the flow of hydraulic fluid between the directional servo valve 10 and the reservoir in order to regulate the hydraulic pressure applied to the hydraulic actuator 2; and a dump servo valve 14 disposed downstream of the hydraulic actuator 2 and interposed between the hydraulic actuator 2 and the reservoir for rapidly draining hydraulic fluid from the hydraulic actuator 2, and thereby allowing the rapid depressurization of the hydraulic actuator 2 and the rapid unloading of a finished sample disc.

The hydraulic circuit 4 includes a power unit generally shown at 30 including a fixed displacement hydraulic pump 8 and a motor 32 for driving the hydraulic pump 8. The hydraulic pump 8 draws hydraulic fluid from a reservoir (not shown) and supplies it to the directional servo valve 10. The directional servo valve 10 is preferably a three position, four-way tandem center directional valve. When shifted to a first position, the directional servo valve delivers pressurized fluid via a first directional outlet port 34 to the hydraulic cylinder 26, thereby forcing the piston 24 to raise and exert pressure on a sample (not shown). When shifted to a second position, the directional servo valve diverts pressurized fluid to the reservoir via a second directional outlet port 36 and allows fluid in the cylinder 26 to drain into the reservoir via the second directional outlet port 34 and a second directional inlet port 40, thereby the allowing the piston 24 to retract away from the sample. The directional servo valve 10 is operated by a servo valve controller 42, typically an electrical solenoid, which is operatively connected to, and is operable by, a programmable logic controller (PLC) 18 described below.

The hydraulic circuit 4 can optionally include a pressure gauge 60, to allow a user to observe hydraulic pressure exerted on the piston 24 in real time. The pressure gauge 60 is preferably disposed in parallel with the hydraulic cylinder 26 and downstream of the pressure transducer 16. The pressure gauge 60 can be a mechanical or electronic gauge. Preferably, it is an electronic gauge that is readable as a virtual gauge image at a user interface 62 of the PLC 18. A snubber 64 can optionally be disposed upstream of the pressure gauge 60, to protect the pressure gauge 60 from damage or inaccurate readings as a result of violent changes in pressure. A screen 66 can be disposed downstream of the hydraulic pump 8, and a filter 68 can be disposed upstream of the hydraulic pump 8, to prevent fluid borne particles from fouling the bores of the valves. The filter 68 is preferably a 5 micron filter capable of withstanding 2500 psi.

The control system 6 includes a hydraulic pressure transducer 16 disposed in parallel with the hydraulic actuator 2 for sensing hydraulic pressure at the hydraulic actuator 2, and a processing mechanism 18, preferably a programmable logic controller (PLC) 18, electronically and communicatively connected to the hydraulic pressure transducer 16, and operatively connected to the directional servo valve 10 (and the directional servo valve controller 42), the proportional valve 12 (and the proportional valve controller 48), and the dump servo valve 14 (and the dump servo valve controller 54). The hydraulic pressure transducer 16 is also therefore disposed in parallel with the hydraulic cylinder 26, for monitoring hydraulic pressure exerted on the piston 24. Preferably, the pressure transducer 16 is selected from the Series 623, 635, 626, and 627 transducers manufactured by Barksdale Control Products Inc., Los Angeles, Calif. The PLC 18 includes at least one computer readable memory 20 for storage of operating instructions and algorithms, and at least one central processing unit (CPU) 22 operable to integrate operating instructions with pressure information and accordingly generate commands to regulate the operation of the hydraulic actuator 2 through commands to the directional servo valve 10, the proportional valve 12, and the dump servo valve 14.

The PLC 18 can be any PLC or other digital computer capable of supporting an operating system stable enough for industrial control, able to withstand the temperature, humidity, and vibration, of the environment in which it is situated, and including sufficient analog outputs 74, and output relays 76 to transmit the commands that are described below. The PLC 18 is operatively connected to the user interface 62 for the entry of operating instructions, preferably in the form of individually entered algorithms, pre-programmed algorithms, and manually entered commands. Preferably, the user interface 62 is a graphical user interface, and most preferably, including both a keyboard and a touch screen to facilitate rapid and flexible user interaction. The user interface 62 can additionally include a removable digital memory device such as an SD card (not shown) for the rapid and secure import and export of programs and data.

The PLC 18 is also operatively connected to an analog/digital (A/D) converter 70 to translate the analog output of the pressure transducer 16 into a digital form usable by the PLC 18. The PLC 18 is also operatively connected to a digital/analog (D/A) converter 72, to translate the digital commands generated by the PLC 18 into analog commands to the proportional valve controller 48. The converters can include any D/A and A/D converters 70, 72 having sufficient bit capacity to allow rapid and continuous communication with the pressure transducer 16 and the proportional valve controller 48. D/A converters 70 with 10 bit capacity and A/D converters 72 with 14 bit capacity are sufficient to allow a sufficiently rapid rate of pressure sampling and adjustment of the proportional valve 12 to provide stable constant pressures and smooth pressure transitions at the piston 24 during programmed operation of the pellet press.

The PLC 18 also includes an internal clock 72, and the CPU 22 can integrate operating instructions with time data and pressure information and accordingly generate commands to regulate the operation of the piston 24 by means of coordinated commands to the directional servo valve controller 42, the proportional valve controller 48, and the dump servo valve controller 54.

An example of a suitable PLC 18 is the Unitronics touchscreen processor V1040-T20B combined with Unitronics V200-18-E2B (Behco, Inc, Warren, Mich.), which provides digital inputs and relay and analog outputs.

Optionally, the PLC 18 is additionally operationally connected to a bar code reader 78 for the input of bar coded information. This information is taken from appropriate bar codes affixed to molds or samples, and it can be used for two possible purposes. First, the bar code can signal the PLC 18 to initiate a specific command algorithm suitable for the processing of the particular type of sample associated with the bar code. Second, the bar code can contain a sample identification tag which the PLC 18 records in memory 20 in association with the command algorithm used to process the sample, and date and time of processing, taken from the internal clock 20. These associations make each sample fully traceable. Traceability is important in fields where sample discs are analyzed for properties related to human health and safety; for example the analysis of the composition of batches of concrete, and the analysis of slag for toxic contaminants.

The PLC 18 can additionally include a scaling mechanism 80, to modify an existing program to account for molds of various diameters. For example, as mold diameter increases, and the pressure exerted per unit of sample area decreases, the scaling mechanism automatically adjusts the execution of a compression program to appropriately increase the hydraulic pressure exerted on the piston 24. Mold dimension information can be entered through the user interface 62 (FIG. 2) or can be encoded in a bar code and entered through the bar code reader 78. This allows for a single set of operating instructions to be applied to molds of varying sizes.

The control system 6 additionally includes a real time pressure feedback control mechanism for automatically maintaining a predetermined pressure level at the hydraulic actuator 2, or for performing a predetermined sequence of pressure changes over time at the hydraulic actuator 2, by regulating the flow of fluid through the proportional valve 12 in accord with both operating instructions and real time pressure information from the hydraulic pressure transducer 16. Preferably, the real time feedback control mechanism includes a proportional-integral-derivative (PID) feedback loop. The PID feedback loop is operable to apply low, constant preloading pressure to the sample, followed by stepped increases in pressure, each stepped increase including a rapid increase in pressure to a predetermined pressure level, followed by maintenance of the predetermined pressure for a predetermined dwell time.

Interposed between the hydraulic pump 8 and the directional servo valve 10 is the normally open proportional valve 12. In its fully open position, the proportional valve completely diverts the flow of fluid from the hydraulic pump 8 into the reservoir, preventing flow to the directional servo valve 12. The flow of fluid in the open position is from a first proportional valve port 44 to a second proportional valve port 46. In its fully closed position, fluid bypasses the directional valve 12 and flows completely to the directional servo valve 10. In intermediate positions, the proportional valve 12 divides the flow of fluid between the reservoir and the directional servo valve 10. The proportional valve 12 is operatively connected to a proportional valve controller 48, preferably an electrical proportional controller, which is operatively connected to, and is operable by, the PLC 18.

The dump servo valve 14 is disposed downstream of the hydraulic cylinder 26, interposed between the hydraulic cylinder 26 and the reservoir. In its open position, the dump servo valve 14 permits fluid to drain from the hydraulic cylinder 26, flowing from a first dump valve port 50 to a second dump valve port 52. This allows the piston 24 to retract away from the sample. The dump servo valve ports 50 and 52 are preferably of at least twice the bore size of the corresponding ports of the directional servo valve 10 and the proportional valve 12, as the function of the dump servo valve 14 is to permit rapid retraction of the piston 24 for sample unloading. The dump servo valve 14 is operatively connected to a dump servo valve controller 54, preferably an electrical solenoid controller, which is operatively connected to, and is operable by, the PLC 18.

There are several advantages to the programmable pellet press 100 of the present invention. The programmable pellet press 100 is capable of executing operating instructions, preferably in the form of command algorithms that command the hydraulic circuit 4 to exert upon a sample a relatively low constant preloading pressure followed by stepwise pressure increases with constant pressure dwell times. This is a novel pressure pattern, which causes voids in the powdered sample to collapse or dissipate before they are locked in by further pressure increases. The elimination of voids from the resulting sample disc increases the integrity of disc during unloading from the mold and under the physical stresses of subsequent analyses. The values for the rate and magnitude of the pressure increases, and for the duration of dwell time, can be determined empirically for each type of sample. The stepped increases in pressure can optionally be followed by a predetermined routine of depressurization. A smooth, gradual decrease in pressure is usually preferred, to reduce stress on the newly formed sample disc.

The programmable pellet press 100 is capable of executing command algorithms with unprecedented precision and consistency because the hydraulic pressure applied to the piston 24 is regulated by the proportional valve 12, which provides far more rapid and exact pressure changes than does the commonly utilized variable displacement pump; and because the proportional valve 12 is regulated by the real time PID feedback loop operated by a control system with sufficient speed to allow hydraulic pressure to be sampled, and proportional valve adjustments to be made, at rates rapid enough to allow the execution of smooth pressure changes and steady pressure dwell times. This avoids the problems associated with feedback loops of the prior art utilizing insufficient sampling and adjustment rates. Such feedback loops constantly lag behind the actual pressure exerted upon a sample, producing frequent pressure oscillations as the control system tries to “catch up” with the specified pressure. These oscillations can do great damage to the integrity of the sample.

The present invention also provides for a method of compressing a powdered sample into a sample disc in the programmable pellet press 100. The preferred method is characterized by stepped increases in pressure exerted upon the powdered sample by the hydraulic actuator 2. This method includes the steps of loading a powdered sample into the mold of the programmable pellet press 100, raising the hydraulically powered piston 24 against the sample at a baseline pressure exerted upon the piston 24, increasing the hydraulic pressure on the piston 24 to maintain a predetermined preloading pressure against the sample for a predetermined period, further raising the pressure in a predetermined series of stepped pressure increases, with the series of stepped pressure increases including at least a first stepped pressure increase 1 and a final stepped pressure increase n. Each stepped pressure increase is accomplished by rapidly increasing the hydraulic pressure to a predetermined pressure, holding the predetermined pressure for a predetermined dwell time, and commencing the succeeding stepped pressure increase, or in the case of stepped pressure increase n, commencing a depressurization sequence. The final dwell time, that is, the dwell time for stepped pressure increase n, is typically longer than that for preceding steps, and can be referred to as the “holding time”. Preferably, the depressurization sequence includes a gradual ramping down of hydraulic pressure, in accord with a predetermined rate of pressure decrease over time, until the hydraulic pressure returns to its baseline level. Ramped decreases in pressure can be executed at linear or nonlinear rates. The sample disc is then unloaded from the mold.

The method produces sample discs of unprecedented structural integrity from a wide variety of powdered samples. For example, the method can be used to compress high silica powder, an extremely difficult powder to pellet without cracking. For high silica powder, pressure is increased in steps of 5,000 lbs, with each step being held at constant pressure for a dwell time of three seconds. During these holding periods, trapped air is purged, and the silica and binder are allowed to compress. When the target pressure, 40,000 lbs, is reached, it is held for 10 seconds. This is followed by a linear decrease in pressure to zero lbs. carried out over a period of 10 seconds.

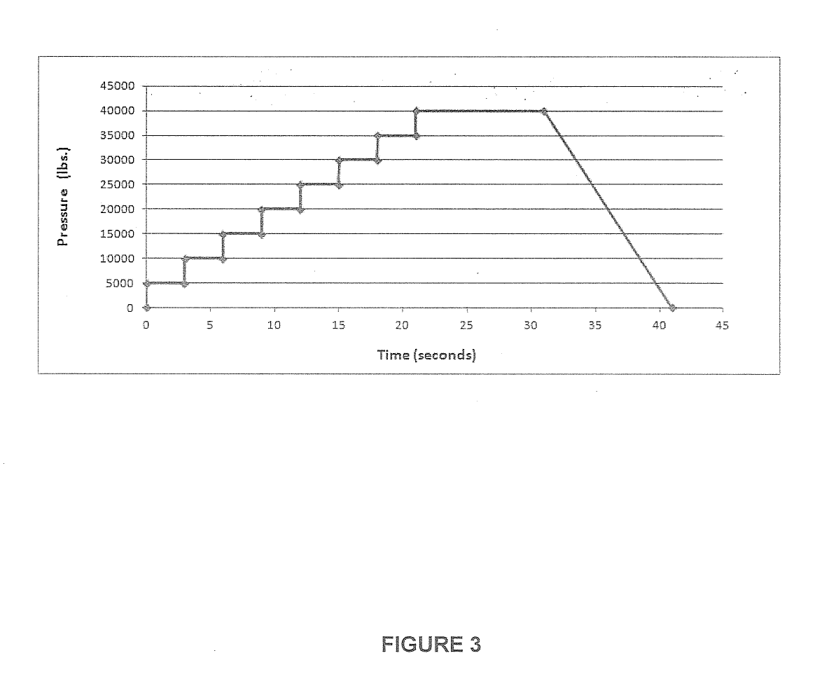

The pressure and time protocol for pressing high silica powder is presented graphically in FIG. 3, as a typical protocol for performing the preferred embodiment of the method, is illustrated in FIG. 3. The graph describes a series of nearly vertical pressurization steps, with the horizontal component each step corresponding to the dwell time for each step, followed by an oblique ramp corresponding to a smooth, steady decrease in pressure back to base line.

Alternative methods, including smooth ramped increases in pressure, as well as stepped decreases in pressure, can be required for atypical sample materials. Such alternative methods are well within the capability of the present invention.

The present invention also includes software products of computer readable memory including sample disc production methods in the form of command algorithms executable as computer programs.

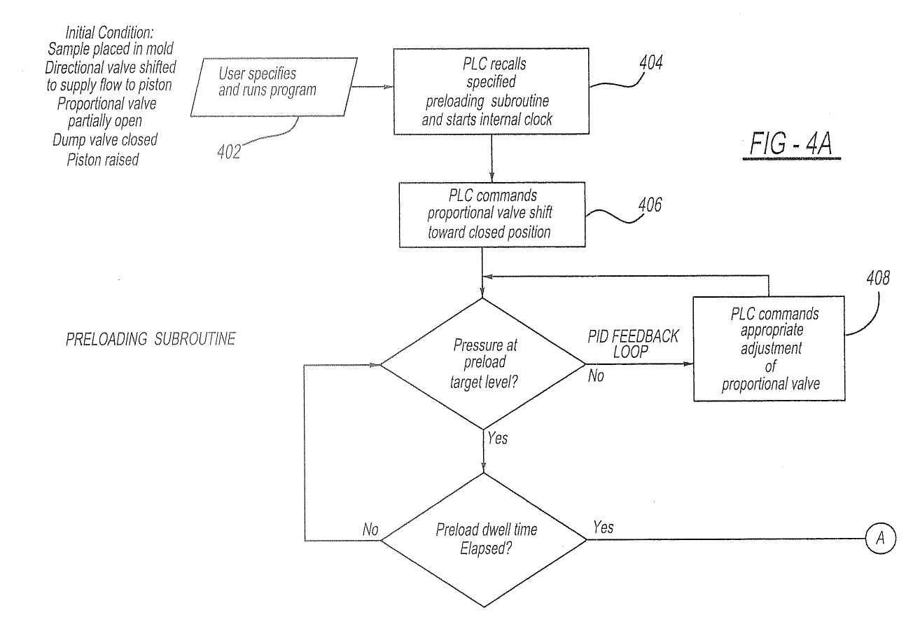

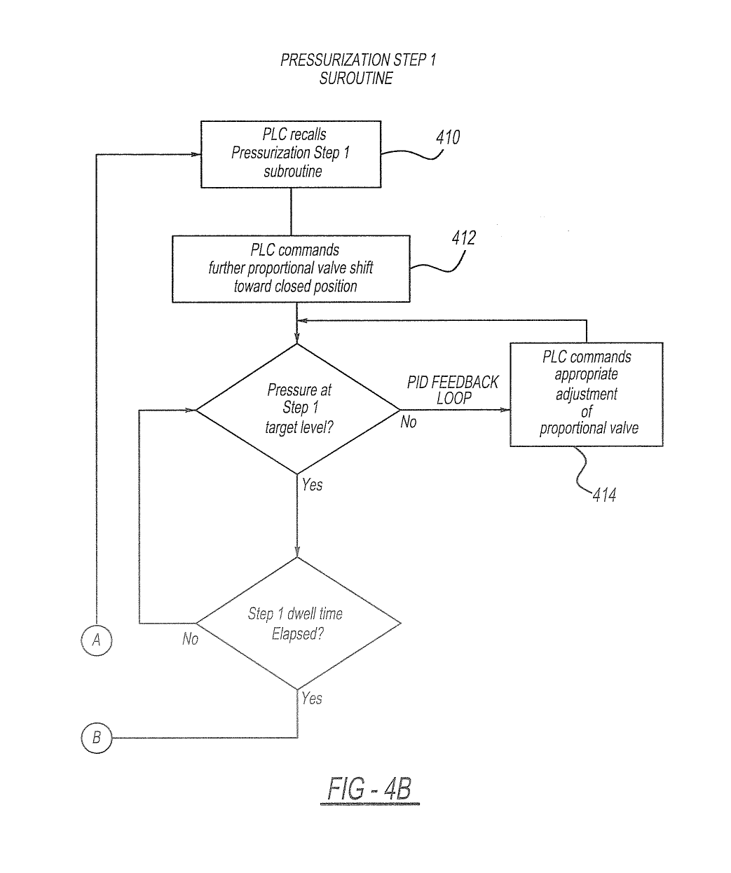

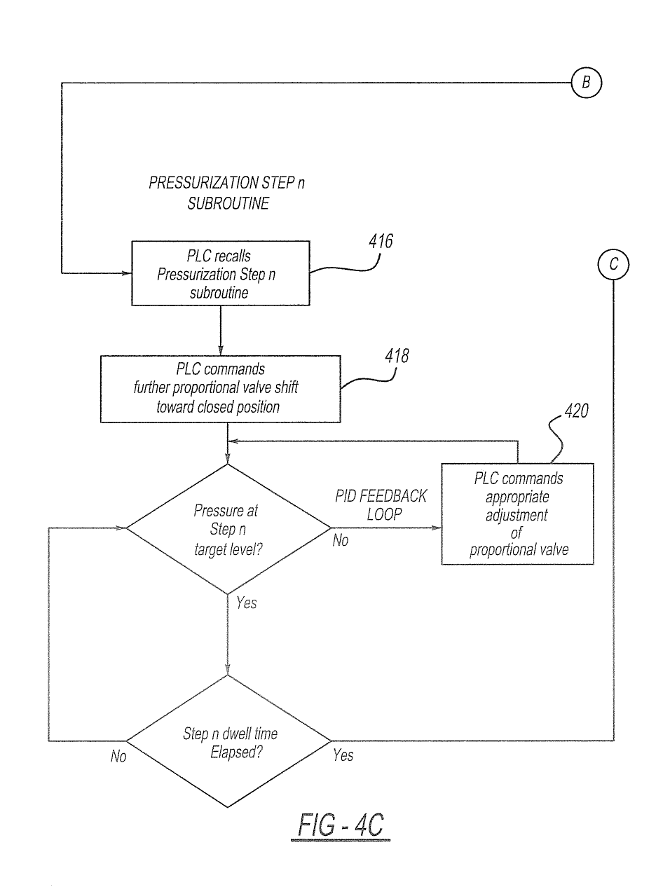

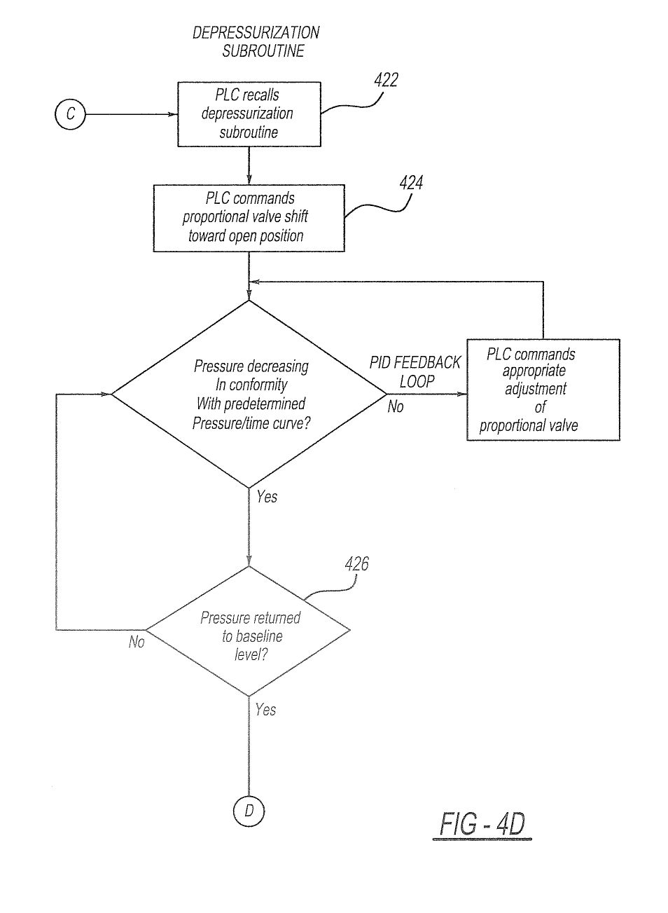

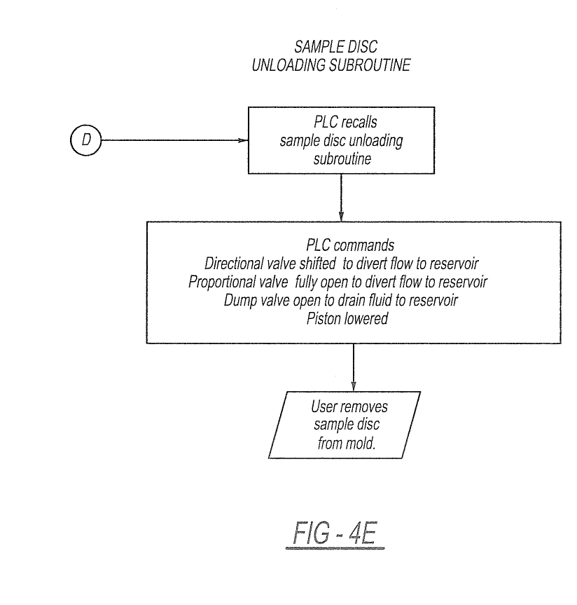

A generalized command algorithm for a sample compression method including stepped increases in pressure and a smooth, ramped depressurization, is summarized in FIG. 4. Briefly, the pellet press is set up by loading a sample into a mold, locking the mold into the bridge or other holder of the pellet press, shifting the directional valve 10 to its first position to deliver pressurized fluid via the first directional outlet port 38 to the hydraulic cylinder 26, and closing the proportional valve 12 to an extent sufficient to pressurize the cylinder 26 to raise the piston 24 against the sample at baseline pressure. The dump servo valve 14 is closed.

An operator orders the execution of a command algorithm, typically in the form of a computer program, and starts the program (FIG. 4, point 402). In response, the PLC 18 recalls the preloading subroutine of the specified program from memory 20 and starts the internal clock 72 (point 404). The PLC 18 then commands proportional valve controller 48, via analog output 74, to shift the proportional valve 12 farther toward the closed position (point 406). With the proportional valve 12 diverting less fluid to the reservoir, pressure exerted upon the piston 24 increases. A PID feedback loop commences, with the PLC 18 monitoring the pressure transducer 16 and comparing the actual pressure to the predetermined preloading pressure level encoded in the program. If the actual pressure is discrepant with the predetermined pressure, the PLC 18 commands an appropriate shift of the proportional control valve 12 toward the open or closed position (point 408), to bring the actual pressure into conformity. The PLC 18 also compares the elapsed dwell time with the specified preloading dwell time for the preloading subroutine, which is also encoded in the program. When the specified dwell time at the preloading pressure has elapsed, the PLC 18 recalls the subroutine for pressurization step 1 (point 410) and commences this subroutine by commanding the proportional valve controller 48 to shift the proportional valve 12 farther toward the closed position (point 412), further increasing pressure exerted on the piston 24. A PID feedback loop commences, with the PLC 18 monitoring the pressure transducer 16 and comparing the actual pressure to the predetermined step 1 pressure level encoded in the program, first to determine whether the target pressure has been reached, and, once it has been reached, to determine whether it is being maintained. If the actual pressure is discrepant with the predetermined pressure, the PLC 18 commands an appropriate shift of the proportional control valve 12 toward the open or closed position (point 414) to bring the actual pressure into conformity. When the specified dwell time at the preloading pressure has elapsed, the PLC 18 recalls and executes the subroutine for each succeeding pressurization step until the final step n has been executed (points 416, 418, 420). At that point, the PLC 18 recalls the subroutine for depressurization (point 422) and commences the subroutine by commanding the proportional valve controller to shift toward the open position (point 424), reducing pressure exerted on the piston 24. A PID feedback loop commences, with the PLC 18 monitoring the pressure transducer 16 and comparing the rate of pressure decline against a predetermined pressure/time curve encoded in the program. If the actual pressure is discrepant, the PLC 18 commands an appropriate shift of the proportional control valve 12 to bring the actual pressure into conformity with the curve. Once pressure returns to the baseline level, the PLC 18 recalls the subroutine for unloading the sample (point 426) and commences this subroutine by commanding the proportional valve 12 to open completely, thereby to divert the flow of fluid to the reservoir, commanding the directional valve 10 to shift to its second position to allow drainage of fluid from the cylinder 26 into the reservoir, and by commanding the dump valve 14 to open, to speed drainage of fluid from the cylinder 26 into the reservoir. With hydraulic pressure relieved from the cylinder 26, the piston 24 is lowered away from the sample by force exerted by its spring return 28. A user can now open the bridge and remove the sample disc.

A typical program can include a program name, the number of pressurization steps, the target pressure and dwell time at each step, the duration of the unloading step.

The components of this generalized command algorithm can readily be rearranged and modified into algorithms for ramped increases in pressure, stepped depressurizations, any combination of stepped increases in pressure, ramped increases in pressure, stepped decreases in pressure, and ramped decreases in pressure.

The control system 6 also facilitates the development of new programs. As represented in FIG. 2, a “record manual commands” function permits a user to experiment by entering manual commands for preload pressures, target pressures and dwell times for stepped pressure increases, and other properties. Command sets proving to produce optimal sample discs for a given sample material can be saved as new command algorithms in the form of executable software.

As represented in FIG. 2, a user can always control the pellet press directly, by entering manual commands to override the operation of a program.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A programmable pellet press for compressing a powdered sample and forming a sample disc, comprising hydraulic means for compressing the sample in a mold operatively and electrically connected to control means for commanding an exertion of low constant preloading pressure followed by pressure increases with constant pressure dwell times upon said hydraulic means.

2. The programmable pellet press of claim 1, wherein said hydraulic means is further defined as a hydraulic actuator including said mold operatively connected to a hydraulic circuit, and said hydraulic actuator includes a piston slidably disposed within a hydraulic cylinder.

3. The programmable pellet press of claim 2, wherein said hydraulic circuit further includes a hydraulic pump supplying hydraulic fluid from a reservoir to said hydraulic actuator, a directional servo valve interposed between said hydraulic pump and said hydraulic actuator, a proportional valve interposed between said hydraulic pump and said directional servo valve, and a dump servo valve downstream of said hydraulic actuator and interposed between said hydraulic actuator and said reservoir.

4. The programmable pellet press of claim 3, wherein said hydraulic circuit further includes a pressure gauge disposed in parallel with said hydraulic cylinder and downstream of said pressure transducer.

5. The programmable pellet press of claim 1, wherein said control means is further defined as a hydraulic pressure transducer disposed in parallel with said hydraulic actuator and a processing mechanism electronically connected to said hydraulic pressure transducer.

6. The programmable pellet press of claim 5, wherein said processing mechanism further includes computer readable memory for storing operating instructions and algorithms, a central processing unit, and a user interface.

7. The programmable pellet press of claim 5, wherein said processing mechanism is further operatively connected to a bar code reader.

8. The programmable pellet press of claim 5, wherein said processing mechanism further includes scaling means for modifying said algorithm to account for molds of various diameters.

9. The programmable pellet press of claim 5, wherein said control means further includes real time pressure feedback control means for maintaining or adjusting pressure on said hydraulic actuator based on real time pressure information from said hydraulic pressure transducer and wherein said real time feedback control means includes a proportional-integral-derivative (PID) feedback loop.

10. An algorithm for a programmable pellet press on computer readable media, including the steps of:
performing a pressurization subroutine;
performing a proportional-integral-derivative (PID) feedback loop;
performing a depressurization subroutine; and
performing an unloading subroutine when pressure is at a baseline level.

11. The algorithm of claim 10, wherein said performing a pressurization subroutine is further defined as commanding a valve to shift towards a closed position and increasing pressure on a piston.

12. The algorithm of claim 10, wherein said performing a PID feedback loop step is further defined as monitoring a pressure transducer and comparing actual pressure to a predetermined preloading pressure level encoded in the algorithm and wherein if the actual pressure is discrepant with the predetermined pressure, the algorithm manipulates the valve to bring the actual pressure into conformity.

13. The algorithm of claim 12, further including the step of comparing elapsed dwell time with a specified preloading dwell time for a preloading subroutine in the algorithm.

14. The algorithm of claim 13, further including the step of commencing a subroutine of moving the valve further towards the closed position when a specified dwell time at the preloading pressure has elapsed and repeating said performing a PID feedback loop step.

15. The algorithm of claim 10, wherein said performing a depressurization subroutine step is further defined as commanding the valve to move towards an open position and reducing pressure on the piston, commencing a PID feedback loop by monitoring the pressure transducer and comparing rate of pressure decline to a predetermined pressure/time curve encoded in the algorithm and wherein if the actual pressure is discrepant with the predetermined pressure/time curve, the algorithm manipulates the valve to bring the actual pressure into conformity.

16. The algorithm of claim 10, wherein said performing an unloading subroutine further includes the steps of commanding the valve to open completely and diverting fluid to a reservoir, commanding a directional valve to shift to allow drainage of fluid to the reservoir, and commanding a dump valve to open to speed drainage of fluid from a cylinder into the reservoir.

17. The algorithm of claim 10, wherein said algorithm includes a predetermined number of pressurization subroutines, a target pressure and dwell time at each step, and the duration of the unloading subroutine.

18. The algorithm of claim 10, wherein said performing a pressurization subroutine step is performed by a method chosen from the group consisting of smooth ramped pressure increases or stepped pressure increases or a combination of smooth ramped pressure increases and stepped pressure increases.

19. The algorithm of claim 10, wherein said performing a depressurization subroutine is performed by a method chosen from the group consisting of smooth ramped pressure decreases or stepped pressure decreases, or a combination of smooth ramped pressure decreases and stepped pressure decreases.

20. A method of compressing a powdered sample into a sample disc, including the steps of:
loading the powdered sample into a mold of a programmable pellet press;
from a baseline pressure, increasing hydraulic pressure and maintaining a preloading pressure against the sample;
performing pressure increases upon the sample;
depressurizing the sample; and
forming a sample disc.

21. The method of claim 20, wherein said performing step is further defined as performing at least a first stepped pressure increase and a final stepped pressure increase n.

22. The method of claim 21, wherein said stepped pressure increase is accomplished by rapidly increasing the hydraulic pressure to a predetermined pressure, holding the predetermined pressure for a predetermined dwell time.

23. The method of claim 22, wherein said stepped pressure increase further includes a step chosen from the group consisting of performing a succeeding stepped pressure increase, and commencing a depressurization sequence at the final stepped pressure increase n.

24. The method of claim 21, wherein said performing step further includes the step of performing at least one smooth ramped pressure increase.

25. The method of claim 20, wherein said performing step is further defined as performing smooth ramped pressure increases.

26. The method of claim 20, wherein said depressurizing step is further defined as gradually ramping down the hydraulic pressure to return to the baseline pressure.

27. The method of claim 26, wherein said ramping down step is performed at a rate chosen from the group consisting of linear and nonlinear.

28. The method of claim 20, wherein said depressurizing step is further defined as performing stepped decreases in pressure.

29. The method of claim 20, wherein said depressurizing step is further defined as performing a combination of gradually ramping down the hydraulic pressure and performing stepped decreases in pressure.

30. A sample disc formed by the method of claim 20.
